(19) United States
(12) Patent Application Publication
(10) Pub. No.: US 2026/0058368 A1
(43) Pub. Date: Feb. 26, 2026

(54) System and Method of Using a Patch Antenna as a Feed Network-to-Antenna Array Transitional Element

(71) Applicant: PCTEL, Inc., Bloomingdale, IL (US)

(72) Inventor: Erin Patrick McGough, Seven Hills, OH (US)

(73) Assignee: PCTEL, Inc., Bloomingdale, IL (US)

(21) Appl. No.: 19/033,894

(22) Filed: Jan. 22, 2025

Related U.S. Application Data
(60) Provisional application No. 63/686,658, filed on Aug. 23, 2024.

(51) Int. Cl. H01Q 5/385; H01Q 9/04

(52) U.S. Cl. CPC H01Q 5/385; H01Q 9/045

(57) ABSTRACT

This disclosure involves a system of using a patch antenna as a feed network-to-antenna array transitional element, the system comprising a driven patch, a first parasitic patch and a second parasitic patch, where the driven patch functions as a feed network-to-antenna array transitional element. The driven patch couples to both the first parasitic patch and the second parasitic patch. A first port of the driven patch couples to the first parasitic patch via an electric field intensity and to the second parasitic patch via a magnetic field intensity. A second port of the driven patch couples to the first parasitic patch via the magnetic field intensity and to the second parasitic patch via the electric field intensity. The magnitude and phase of the coupled fields change by tuning a gap between the driven patch and the first parasitic patch and a gap between the driven patch and the second parasitic patch.

### CROSS-REFERENCE TO RELATED APPLICATION

1This application claims priority to U.S. provisional application Ser. No. 63/686,658, filed on Aug. 23, 2024, which is incorporated herein by reference.

### FIELD OF INVENTION

This disclosure generally relates to utilizing both an electric field and a magnetic field coupling to feed an array of antennas.

### BACKGROUND OF INVENTION

There exist many solutions where an antenna element is designed to couple to another antenna element (e.g., aperture-coupled patch, Yagi-Uda antenna array) or where a transmission line is designed to couple to an antenna element (e.g., proximity-coupled patch). There also exist solutions that employ one or more parasitic elements at favorable locations around a driven element to achieve certain radiation or s-parameter characteristics.

One such solution is that of Z. Shao and Y. Zhang (Z. Shao and Y. Zhang, “Cross-Polarization Reduction of Shorted Patch Antenna by Using Coupled TM0,½ Mode,” in IEEE Transactions on Antennas and Propagation, vol. 69, no. 12, pp. 8115-8124, Dec. 2021, doi: 10.1109/TAP.2021.3111503. keywords: {Electromagnetic compatibility; Electric fields; Patch antennas; Antennas; Substrates; Pins; Probes; Coupled mode; cross-polarization reduction; microstrip antennas; shorted patch antenna (SPA)}.

Many past configurations were all “side-to-side” not “end-to-end”; i.e., the electromagnetic coupling is via the magnetic field intensity (or surface current density). These past configurations included coupling between closely-spaced driven and parasitic shorted quarter-wave patch antennas with the aim of minimizing the cross-polarization incurred by shorting the patches. For example, the configuration of Z. Shao and Y. Zhang couples RF power from a driven patch to two shorted quarter-wavelength patch antennas via the magnetic field with the aim of minimizing the cross-polarization incurred by shorting the patches.

### SUMMARY OF THE INVENTION

The disclosure involves a system of using a patch antenna as a feed network-to-antenna array transitional element that includes a driven patch, a first parasitic patch and a second parasitic patch, where the driven patch functions as a feed network-to-antenna array transitional element. The driven patch couples to both the first parasitic patch and the second parasitic patch. The system further includes a first port of the driven patch that couples to the first parasitic patch via an electric field intensity and to the second parasitic patch via a magnetic field intensity. The system further includes a second port of the driven patch that couples to the first parasitic patch via the magnetic field intensity and to the second parasitic patch via the electric field intensity, wherein tuning a gap between the driven patch and the first parasitic patch as well as a gap between the driven patch and the second parasitic patch changes the magnitude and phase of the coupled fields.

In one aspect, the driven patch is a half-wavelength resonant, octagonal patch.

In one aspect, the first parasitic patch and the second parasitic patch are half-wavelength resonant, octagonal patches.

In one aspect, the driven patch, the first parasitic patch, and the second parasitic patch are the same size.

In one aspect, tuning results in an in-phase excitation of the 2×1 linear parasitic array.

In one aspect, the system further comprises a circuit.

In one aspect, the circuit may be realized on a 60 mil thick woven glass-reinforced ceramic substrate.

In one aspect, the circuit comprises a first inductor in series with a first transmission line from the first port of the driven patch and a second inductor in series with a second transmission line from the second port of the driven patch.

In one aspect, the first inductor and the second inductor are 3.9 nH.

The disclosure involves a system of using a patch antenna as a feed network-to-antenna array transitional element including a driven patch, a first parasitic patch and a second parasitic patch, where the driven patch functions as a feed network-to-antenna array transitional element. The driven patch couples to both the first parasitic patch and the second parasitic patch. The system further includes a first port of the driven patch that couples to the first parasitic patch via an electric field intensity and to the second parasitic patch via a magnetic field intensity. The system further includes a second port of the driven patch that couples to the first parasitic patch via the magnetic field intensity and to the second parasitic patch via the electric field intensity. The system further includes a circuit. The circuit includes a first inductor and a second inductor. The first inductor is in series with a first transmission line from the first port of the driven patch, and the second inductor is in series with a second transmission line from the second port of the driven patch.

In one aspect, the driven patch is a half-wavelength resonant, octagonal patch.

In one aspect, the first parasitic patch and the second parasitic patch are half-wavelength resonant, octagonal patches.

In one aspect, the driven patch, the first parasitic patch, and the second parasitic patch are the same size.

In one aspect, tuning a gap between the driven patch and the first parasitic patch and a gap between the driven patch and the second parasitic patch changes the magnitude and phase of the coupled fields.

In one aspect, tuning results in an in-phase excitation of the 2×1 linear parasitic array.

In one aspect, the first inductor and the second inductor are 3.9 nH.

In one aspect, the circuit may be realized on a 60 mil thick woven glass-reinforced ceramic substrate.

The disclosure involves a method of using a patch antenna as a feed network-to-antenna array transitional element, the method that includes having a driven patch, where the driven patch functions as a feed network-to-antenna array transitional element. The method further includes coupling a first parasitic patch and a second parasitic patch to the driven patch. The method further includes coupling a first port of the driven patch to the first parasitic patch via an electric field intensity and to the second parasitic patch via a magnetic field intensity. The method further including coupling a second port of the driven patch to the first parasitic patch via the magnetic field intensity and to the second parasitic patch via the electric field intensity. Tuning a gap between the driven patch and the first parasitic patch and a gap between the driven patch and the second parasitic patch changes the magnitude and phase of the coupled fields.

In one aspect, the driven patch, the first parasitic patch, and the second parasitic patch are half-wavelength resonant, octagonal patches.

In one aspect, the driven patch, the first parasitic patch, and the second parasitic patch are the same size.

In one aspect, tuning results in an in-phase excitation of the 2×1 linear parasitic array.

In one aspect, the method further includes having a circuit. The circuit is realized on a 60 mil thick woven glass-reinforced ceramic substrate. The circuit includes a first inductor in series with a first transmission line from the first port of the driven patch and a second inductor in series with a second transmission line from the second port of the driven patch, wherein the first inductor and the second inductor are 3.9 nH.

### BRIEF DESCRIPTION OF THE DRAWINGS

In the drawings forming a part of this disclosure:

FIG. 1 shows the Smith Chart plot of the input impedance locus of a typical 2.45 GHz patch antenna on a thin substrate.

FIG. 2 shows the Smith Chart plot of the input impedance locus of a system that uses a patch antenna as a feed network-to-antenna array transitional element.

FIG. 3 shows a graph of an elevation plane radiation pattern of a single patch antenna.

FIG. 4 shows a graph of an elevation plane radiation pattern of a system that uses a patch antenna as a feed network-to-antenna array transitional element.

FIG. 5 shows a CAD model of a system that uses a patch antenna as a feed network-to-antenna array transitional element.

FIG. 6 shows an electric field configuration in the plane of the patches of the system in FIG. 5 that uses a patch antenna as a feed network-to-antenna array transitional element.

FIG. 7 shows a magnetic field configuration in the plane of the patches of the system in FIG. 5 that uses a patch antenna as a feed network-to-antenna array transitional element.

FIG. 8 shows a surface current distribution of the system in FIG. 5 that uses a patch antenna as a feed network-to-antenna array transitional element.

FIG. 9 shows a graph of matched s-parameters of the system in FIG. 5 that uses a patch antenna as a feed network-to-antenna array transitional element.

FIG. 10 shows a matching circuit of the system in FIG. 5 that uses a patch antenna as a feed network-to-antenna array transitional element.

FIG. 11 shows an electric field at the boundary of the Driven and Parasitic Patch #1 of the system in FIG. 5 that uses a patch antenna as a feed network-to-antenna array transitional element.

FIG. 12 shows the surface current at the boundary of the Driven and Parasitic Patch #2 of the system in FIG. 5 that uses a patch antenna as a feed network-to-antenna array transitional element.

FIG. 13 shows a graph of a +45°-polarized port azimuth plane radiation pattern.

FIG. 14 shows a graph of a −45°-polarized port azimuth plane radiation pattern.

FIG. 15 shows a graph of a +45°-polarized port elevation plane radiation pattern.

FIG. 16 shows a graph of a −45°-polarized port elevation plane radiation pattern.

FIG. 17 shows a 4×4 MIMO system built from two instances of the system presented in FIG. 5 that utilizes a patch antenna as a feed network-to-antenna array transitional element.

### DETAILED DESCRIPTION

Before explaining the disclosed embodiment of the present disclosure in detail, it is to be understood that the invention is not limited in its application to the details of the particular arrangement shown since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and can be practiced or carried out in various ways. Also, it is to be understood that the phraseology and terminology used herein are for the purpose of description and should not be regarded as limiting. For example, the use of “including,” “comprising,” or “having” and variations thereof herein is meant to encompass the items listed thereafter and equivalents thereof, as well as additional items.

As used herein, unless otherwise specified or limited, the term “coupled” and variations thereof are used broadly and encompass both direct and indirect mountings, connections, supports, and couplings. Further, unless otherwise specified or limited, “coupled” is not restricted to physical or mechanical connections or couplings.

The present disclosure utilizes both an electric field and a magnetic field coupling to feed an array of antennas. Allowing coupling to occur side-to-side as well as end-to-end allows for feeding a 2×1 linear array using a single element.

The present disclosure provides a way to excite an antenna array using a single antenna element that is driven by a transmission line. This configuration saves space by simplifying trace routing and eliminating the need for impedance transformations and long transmission lines.

The present disclosure also provides a way to excite a dual-polarized array. In the present disclosure, the single “transitional” antenna element can be excited to support orthogonal polarizations with each polarization corresponding to a unique radio port. This reuse of the same physical copper in the present disclosure saves space and cost.

The array elements in the present disclosure increase the design parameter space and enable an increase in impedance bandwidth. When the array of antennas is excited in the present disclosure, the beamwidth, in at least one plane, will be reduced compared to the beamwidth of a single driven element. The reduction in beamwidth incorporated in the present disclosure corresponds to an increase in forward gain, which may be desirable in a variety of applications.

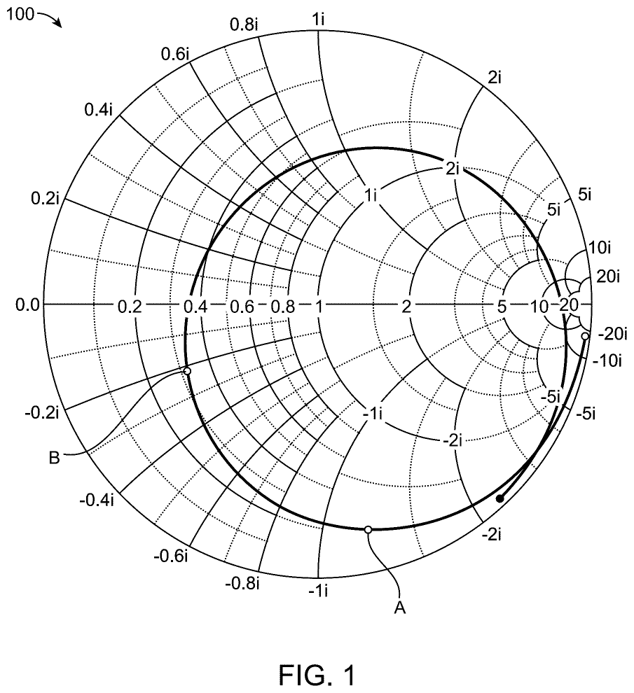

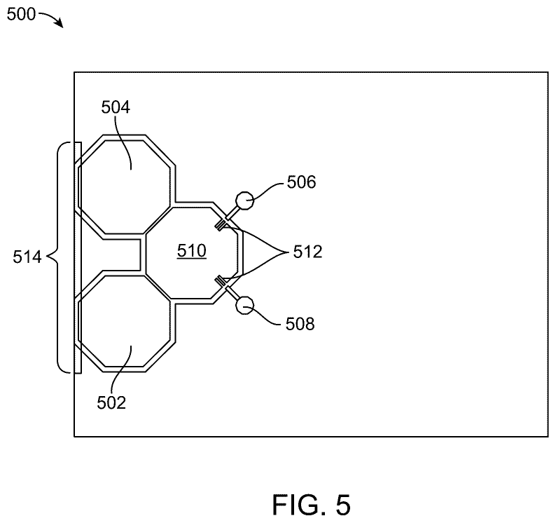

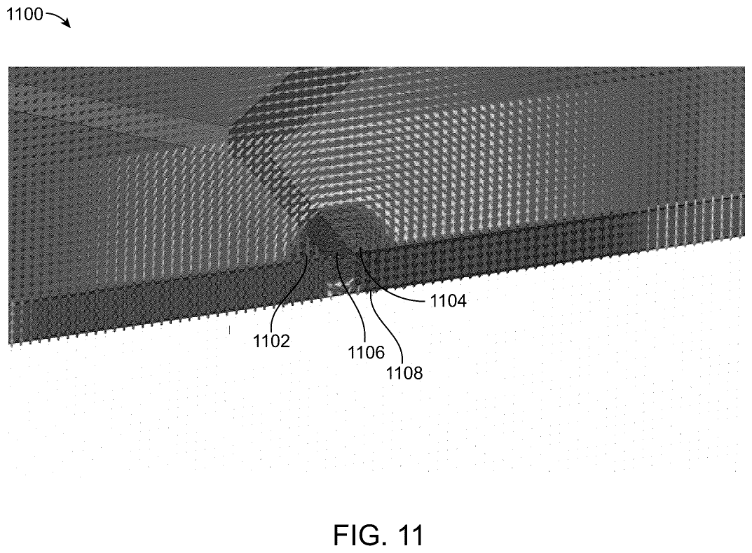

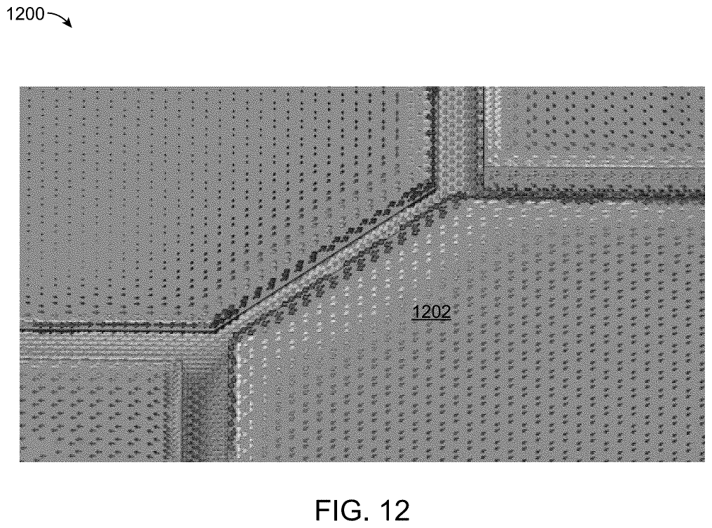

The system and method of using a patch antenna as a feed network-to-antenna array transitional element of the present disclosure may, in some instances, reduce feed network complexity, save space, and increase efficiency. Additionally, in some instances, using a patch antenna as a feed network-to-antenna array element may increase the impedance bandwidth and reduce the beamwidth compared to a standalone patch design. In FIG. 1, graph 100, for example, is a Smith Chart plot that illustrates the input impedance locus of a single excited patch (without the parasitic array present) of a typical 2.45 GHz patch antenna on a thin substrate. In other instances, the patch antenna is not limited to 2.45 GHz and may be other sizes and/or resonant at a different frequency or different frequencies. The spread in the input impedance locus from 2.4 GHz through 2.49 GHz is shown in graph 100. In some instances, a thin substrate may be used. However, in other instances, a different, thicker substrate may be used. In the embodiment shown in graph 100, for example, the patch antenna is on a thin (<0.02λ) substrate. In some embodiments, a 50 Ohm reference impedance may be used. However, in other embodiments, a different reference impedance may be used. Shown in the embodiment in graph 100, for example, a 50 Ohm reference impedance is used. The impedance is a complex value and is shown at Point A at 2.40 GHz as 11.014661, −61.071891 [Ohm] on graph 100. Likewise, Point B at 2.49 GHz is shown as 15.759345, −j11.097577 [Ohm] on graph 100. The variation in input impedance over the operating band 2.4 GHz through 2.49 GHz makes the antenna difficult to match to a transmission line. The driven patch antenna of graph 100 acts as a transitional element that maps the electromagnetic fields at the input transmission line to the fields radiated by an array. The transitional element couples to the adjacent patch via the magnetic field (shown in FIG. 12). The transitional element further couples to the end patch via the electric field (shown in FIG. 11). The transitional element accepts power from a transmission line, modifies the electric and magnetic field configurations, and conveys the power to a 2×1 inear array for radiation. The 2×1 linear array is discussed later in FIG. 5 in the transmit mode.

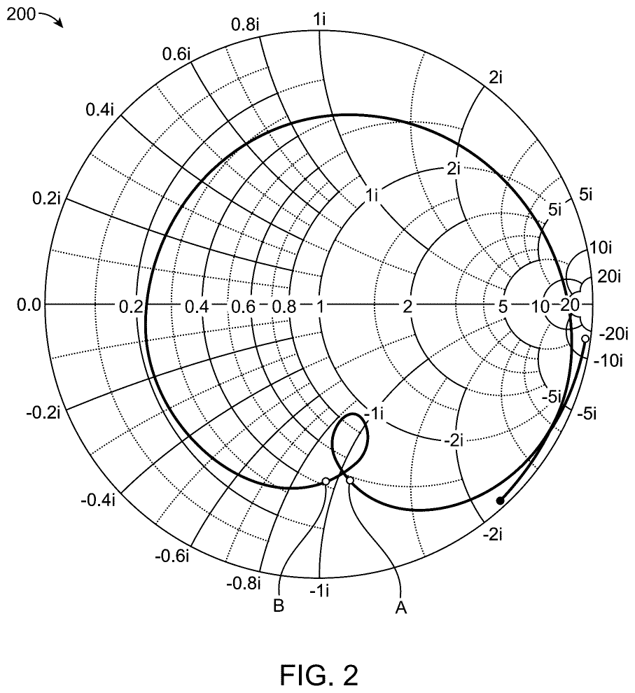

Turning to FIG. 2, graph 200 is a Smith Chart plot of the input impedance locus of the present disclosure. In the example plot illustrated in graph 200, a 50 Ohm reference impedance is used. On graph 200, the impedance is a complex value shown at Point A at 2.40 GHz as 23.560172, −j53.775302 [Ohm]. Likewise, Point B at 2.49 GHz is shown as 21.423153, −j47.318019 [Ohm] on graph 200. The input impedance locus may be much tighter and may also be matched using a single distributed line section or lumped element. It is noted that the simulated results (shown in graph 100 and graph 200) are taken from the model described later in FIG. 5, system 500, with and without the parasitic patches in place so that the utility of the present disclosure may be apparent.

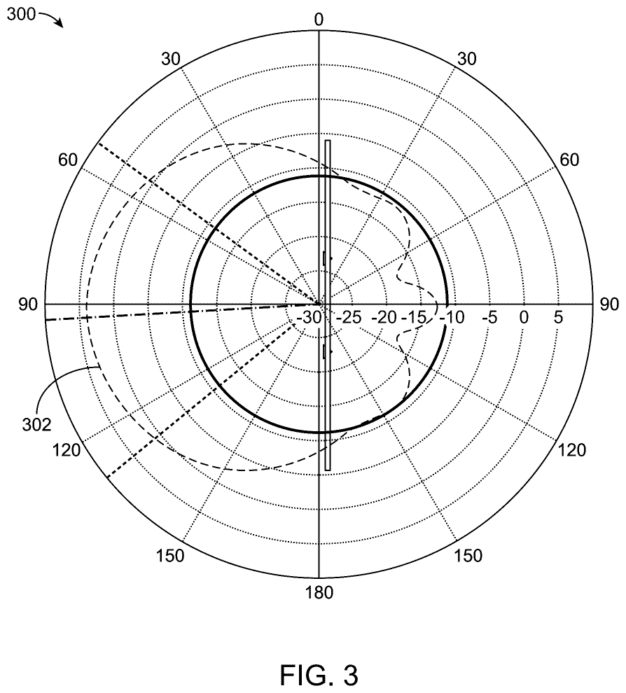

An example of an elevation plane beamwidth of a single (slant −45°-polarized) patch antenna is shown in FIG. 3, graph 300. In the example shown in graph 300, the frequency is 2.45 GHz with a main lobe magnitude of 3.8 dBi, a main lobe direction of 93 degrees, an angular width (3 dB) of 75.4 degrees, and a side lobe level of −14.9 dB. Curve 302 represents a simulation performed at 2.45 GHz. The present disclosure achieves a significant reduction in elevation plane beamwidth compared to the elevation plane beamwidth of the standalone patch antenna of graph 300.

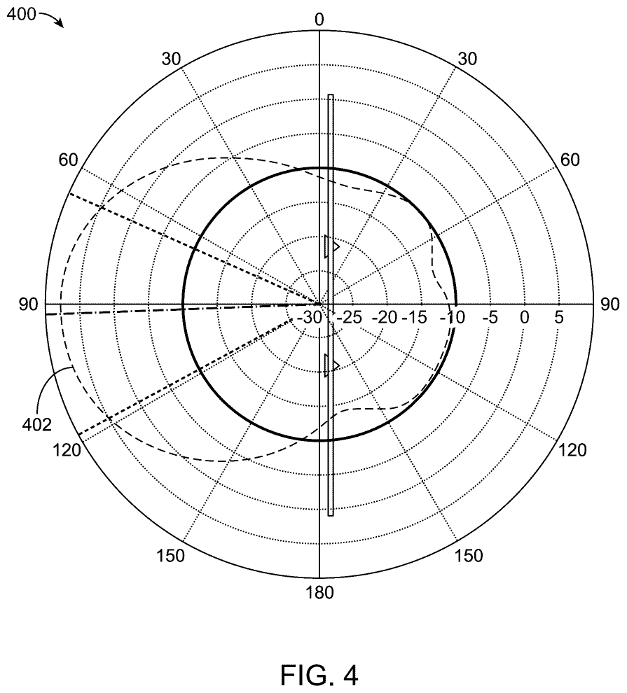

An example of an elevation plane beamwidth of the present disclosure (slant −45°-polarized) is shown in FIG. 4, graph 400. In the example shown in graph 400, the frequency is 2.45 GHz with a main lobe magnitude of 7.9 dBi, a main lobe direction of 92.0 degrees, an angular width (3 dB) of 52.4 degrees, and a side lobe level of −17.8 dB. Curve 402 represents a simulation performed at 2.45 GHz. In the example shown in graph 400, the elevation plane beamwidth is shown to be reduced by more than twenty degrees as compared to the simulation of the single patch antenna of graph 300. A reduction in elevation plane beamwidth indicates good coupling from the driven patch to the parasitic array and substantiates the patch as a feed network-to-array transitional element.

Turning to FIG. 5, system 500 is shown as a CAD model that uses a patch antenna as a feed network-to-antenna array transitional element. In the example shown in system 500, a 60 mil thick woven glass-reinforced ceramic substrate may be used and may be fabricated on a printed circuit board. In other instances, a different substrate may be used. In other instances, for example, the substrate may be thicker or thinner and may be made from a different material. For example, in one instance, the substrate may be a sheet of plastic. In another instance, however, the substrate may be a printed circuit board laminate or substrate of another kind, so long as the properties are suitable for fabrication and electromagnetic performance. In another instances, the substrate may have a thickness range of 30 mils to 200 mils. For example, in one instance, the substrate may be made using Aerowave 300. In other instances, the substrate may be made using other techniques. In the example representation in FIG. 5, system 500 displays a 50 Ohm reference impedance and coplanar waveguide with ground transmission lines. System 500 may further include a parasitic patch #1 502, a parasitic patch #2 504, a +45°-polarized port #1 506, a −45°-polarized port #2 508, a driven patch 510, a high impedance transition for isolation control 512 and a boundary 514, as well as other elements.

In the 3D model shown as system 500, a single patch (i.e., Driven Patch 510) may be excited and couple to both parasitic patches. System 500 showcases fundamental mode, half-wavelength resonant, octagonal patches. In other instances, the patches may be other types and shapes. For example, in another instance, the patches may be circular, triangular, rectangular, flat, or another shape. Further, in another instance, the patches may be a different type, such as, for example, a quarter-wavelength resonant, or a full-wavelength resonant. The Driven Patch 510 of system 500 has two ports. In one instance, the ports may operate independently. The present disclosure is not limited to independent operation of the ports. In another instance, for example, the ports may operate together. Additionally, in one instance, the patches may all be the same size. In FIG. 5, system 500, for example, all the patches are the same size. However, the present disclosure is not limited to having all the patches the same size. In another instance, for example, the patches may be different sizes.

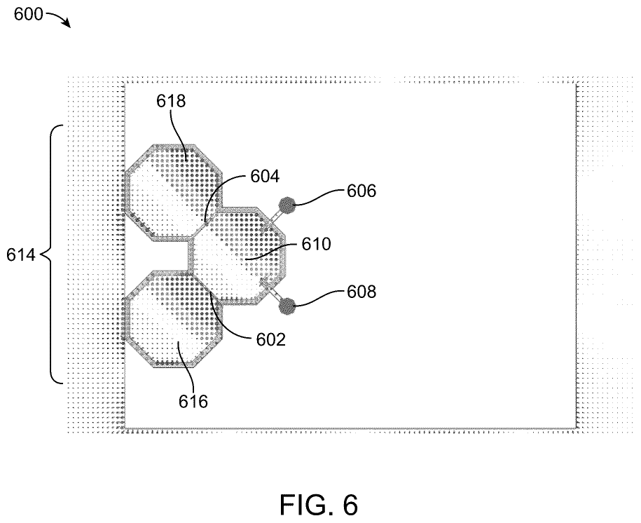

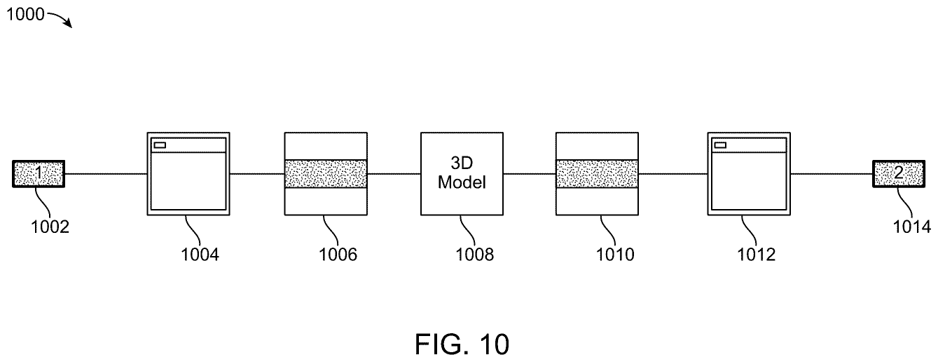

In FIG. 6, graph 600 shows an electric field configuration in the plane of the patches of the system in FIG. 5. In the example shown in graph 600, the electric field configuration may include an electric field coupling 602, an electric field null 604, an excited port 606, an isolated port 608, a driven patch 610, a boundary 614, a Parasitic Patch #1 616, and a Parasitic Patch #2 618, as well as other elements. In graph 600, Port #1 may be the excited port 606, the boundary of Parasitic Patch #1 616 and the Driven Patch 610 may correspond to a location of the electric field coupling 602, and the boundary of Parasitic Patch #2 618 and Driven Patch 610 may correspond to a location of an electric field null 604. In FIG. 6, graph 600, Port #1 606 may couple to Parasitic Patch #1 616, via the electric field intensity, and Port #1 606 may couple to Parasitic Patch #2 618, via the magnetic field intensity. Proper tuning of the antenna may result in an in-phase excitation of the 2×1 linear parasitic array. Two objectives to strive for when tuning an antenna may include, but are not limited to: (1) that the coupled amplitudes and phases on the side and edge patches are identical, and (2) that the real part of the input impedance looking into the transitional element may be close to 50 Ohms so that the system can be matched with a single series component, as shown later in FIG. 10. The simplest form of tuning may be accomplished by varying the size of the patches and the gap between the patches. Many other variables, such as substrate thickness, may also be used as a tuning variable.

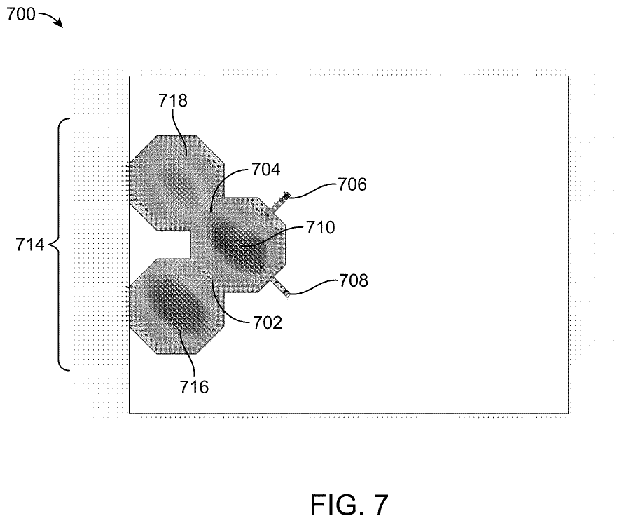

In FIG. 7, graph 700 shows a magnetic field configuration in the plane of the patches of the system in FIG. 5. In the example shown in graph 700, the magnetic field configuration may include a magnetic field null 702, a magnetic field coupling 704, an excited port 706, an isolated port 708, a driven patch 710, a boundary 714, a Parasitic Patch #1 716, and a Parasitic Patch #2 718, as well as other elements. In graph 700, Port #1 may be the excited port 706, the boundary of Parasitic Patch #1 716 and Driven Patch 710 may correspond to a location of a magnetic field null 702, and the boundary of Parasitic Patch #2 718 and Driven Patch 710 may correspond to a location of magnetic field coupling 704. Port #1 706 may couple to Parasitic Patch #1 716, via the electric field intensity, and Port #1 706 may couple to Parasitic Patch #2 718, via the magnetic field intensity. Proper tuning of the antenna results in an in-phase excitation of the 2×1 linear parasitic array. As stated above, two objectives to strive for when tuning the antenna may include, but are not limited to: (1) that the coupled amplitudes and phases on the side and edge patches are identical, and (2) that the real part of the input impedance looking into the transitional element may be close to 50 Ohms so that the system can be matched with a single series component, as shown later in FIG. 10. The simplest form of tuning may be accomplished by varying the size of the patches and the gap between the patches. Many other variables, such as substrate thickness, may also be used as a tuning variable.

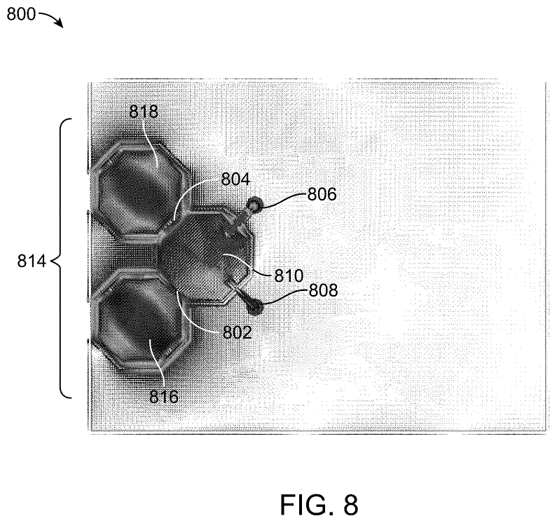

In FIG. 8, graph 800 shows the surface current distribution of the system in FIG. 5. In graph 800, the surface current distribution may include a surface current null 802, a location of high surface current 804, an excited port 806, an isolated port 808, a driven patch 810, a boundary 814, a Parasitic Patch #1 816, and a Parasitic Patch #2 818, as well as other elements. In the embodiment of FIG. 8, Port #2 may be the isolated port 808, the boundary of Parasitic Patch #1 816 and Driven Patch 810 may correspond to a surface current null 802, and the boundary of Parasitic Patch #2 818 and Driven Patch 810 may correspond to high surface current 804. Port #2 808 may couple to Parasitic Patch #1 816, via the magnetic field, and Port #2 808 may couple to Parasitic Patch #2 818, via the electric field.

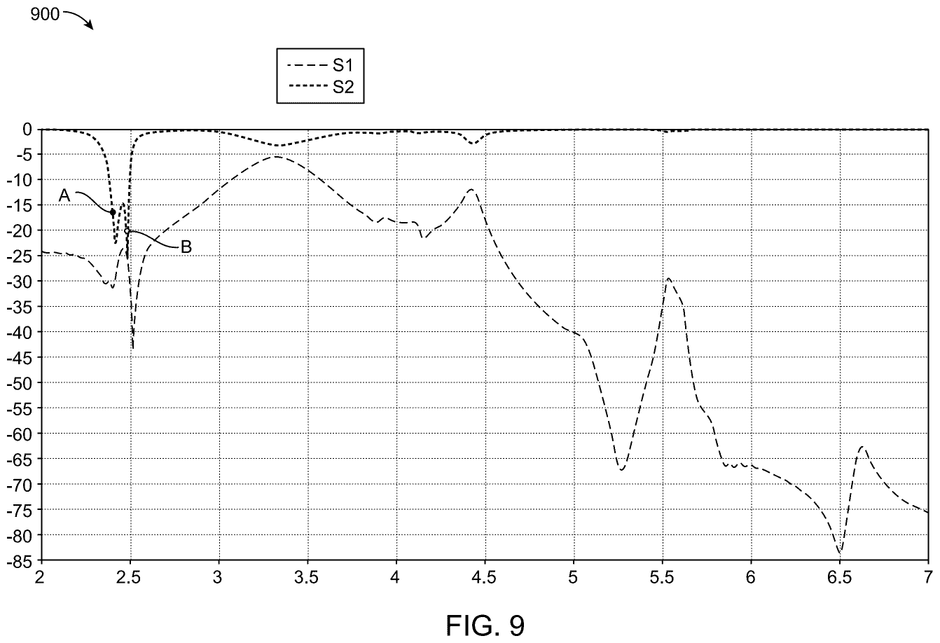

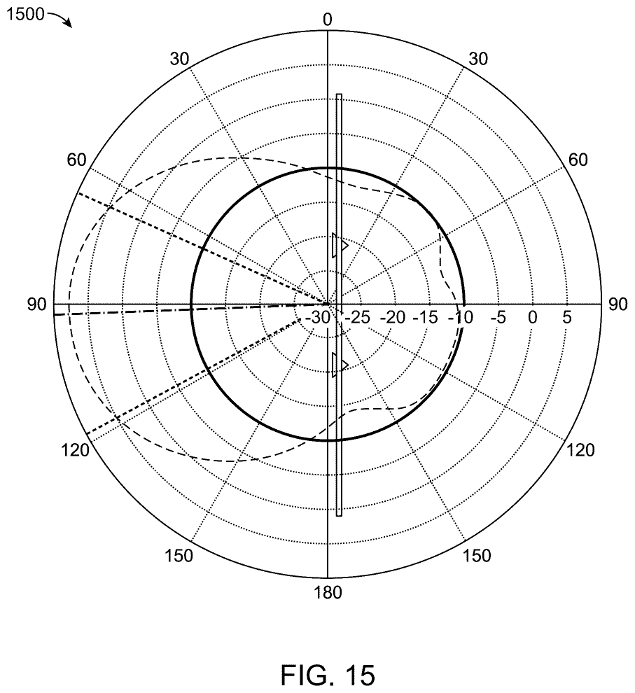

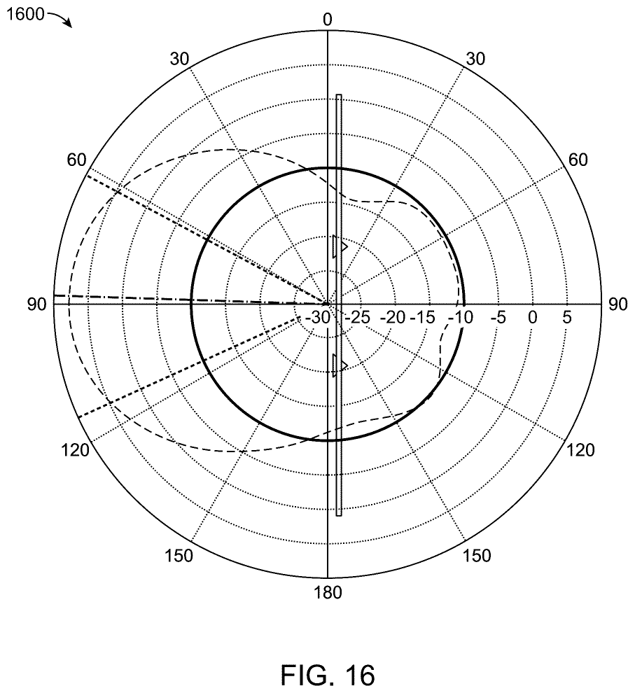

In one instance, the gap between the driven and parasitic patches may be tuned to change the magnitude of the coupled fields. In another instance, the gap between the driven and parasitic patches may be tuned to change the phase of the coupled fields. Improper tuning may result in an amplitude and/or phase imbalance which ultimately affects the radiation pattern shape. For example, an amplitude imbalance increases the elevation plane beamwidth while a phase imbalance moves the elevation plane main beam's takeoff angle off boresight. The elevation plane cuts (shown later in FIG. 15 and FIG. 16) show that the main beam is nearly broadside-directed, which may be desirable for many applications. Additionally, improper tuning may not allow for the antenna system to be matched using a single series component. Additionally, in one instance, the isolation between the ports may be controlled by the boundary location and the length of the high impedance line sections that feed the Driven Patch. In one instance, for example, the boundary location may be at the left. In another instance, the boundary location may be in a different location, such as, for example, at the right. Patch antennas belong to the class of standing wave antennas. Standing wave antennas (e.g., dipoles, apertures, etc.) may rely on open (or short) circuit conditions to determine the current distribution on the antenna. Moving the open circuit condition, or boundary, may affect the current distribution on the patch. For example, when a patch has two feeds, such as in graph 800, the change in the current distribution due to a change in the boundary may affect the coupling, or isolation, from one port on the patch to the other. A very good isolation may be achieved for an inset-fed dual-polarized patch (>23 dB). Generally, 20 dB of isolation may be sufficient for two ports connected to the same radio. The s-parameters of the system in FIG. 5 are further shown in FIG. 9, graph 900. Graph 900 illustrates a graph of matched s-parameters in magnitude of the system in FIG. 5. In graph 900, the y-axis is in dB and the x-axis is in Frequency/GHz. In graph 900, Point A may be at coordinates 2.402, −16.45511. Point B may be at coordinates 2.484, −21.02293 in graph 900. In other words, graph 900 shows the return loss may be better than −16 dB over the operating band 2.4 GHz through 2.49 GHz.

Additionally, a matching circuit of the system in FIG. 5 is shown in circuit 1000 of FIG. 10. In one instance, the matching circuit shown in circuit 1000 may consist of a single series 3.9 [nH] inductor at each port. Circuit 1000 may include a Port 1 1002, inductor 1004, a transmission line 1006, a 3D model 1008, a transmission line 1010, an inductor 1012, and a Port 2 1014. Circuit 1000 may be a combined simulation where the results simulated in the 3D model are used in a schematic simulator to determine the best value of the matching inductor. Inductors 1004 and 1012 are both 3.9 nH. In circuit 1000, inductor 1004 is connected in series with transmission line 1006 from Port 1 1002. Additionally, in circuit 1000, inductor 1012 is connected in series with transmission line 1010 from Port 2 1014. In one instance, the inductor may match the antenna over the desired band (2.4 - 2.484 GHz) and act as a choke above 5 GHz. The de-tuning of the s-parameters above 5 GHz may be a desirable feature in some wireless systems. For example, the s-parameters may be detuned above 5 GHz at the 2.4 GHz ports because the series inductor acts as single element low-pass filter. The underlying point may be to develop antennas that are efficient when in-band and inefficient when out of band. The efficiency when in-band and inefficiency when out of band may help to isolate radios from one another, especially when multiple antenna arrays are collocated within the same housing. The circuit may not be limited to the components shown in circuit 1000. In other instances, the circuit may include more or less inductors. Additionally, in other instances, the circuit may include more or less ports. In other instances, the circuit may include other circuit components such as, for example, one or more of each of resistors, capacitors, amplifiers, diodes, inductors, filters, mixers, oscillators, modulators, and other circuitry components.

The present disclosure considers the field configurations at the two loaded boundaries of the Driven Patch. For example, FIG. 11, graph 1100, may show a single time instant of the electric field at the boundary of the Driven Patch and the Parasitic Patch #1 of the system in FIG. 5. Graph 1100, for example, may show the boundary of Parasitic Patch #1 and the Driven Patch when Port #1 is excited.

In the embodiment shown in graph 1100, the electric field in the gap between the patches may show the capacitive relationship between the Driven Patch and Parasitic Patches. Graph 1100 may include a low voltage point 1102, a high voltage point 1104, a capacitive coupling-high electric field 1106, and a ground 1108, as well as other elements. When the high voltage point 1104 (+V) is at the end of the Driven Patch, such as at a first incidence, an electric field may be established from the Driven Patch to the Parasitic Patch as illustrated in graph 1100. The electric field shown in the embodiment shown in graph 1100 produces a low voltage point 1102 at the end of the Parasitic Patch. The electric field phase at the end of the Parasitic Patch leads the electric field phase at the end of the Driven Patch by about 90-degrees in the embodiment shown in graph 1100. This may be a common high-pass filter (series C) characteristic.

In FIG. 12, graph 1200 may show an example of a single time instant of the surface current at the boundary of Parasitic Patch #2 and Driven Patch 1202 of the system given in FIG. 5 when Port #1 is excited. Coupling via the magnetic field intensity may be best illustrated by viewing the surface current distribution at the boundary of Parasitic Patch #2 and the Driven Patch 1202 when Port #1 is excited. The frequency in graph 1200 is 2.45 GHz, phase is 112.5°, and a maximum (solver) is 196.35 A/m. Graph 1200 may show an induced current on the parasitic patch in the opposite direction. The induced current on the parasitic patch in the opposite direction may be referred to as odd mode coupling.

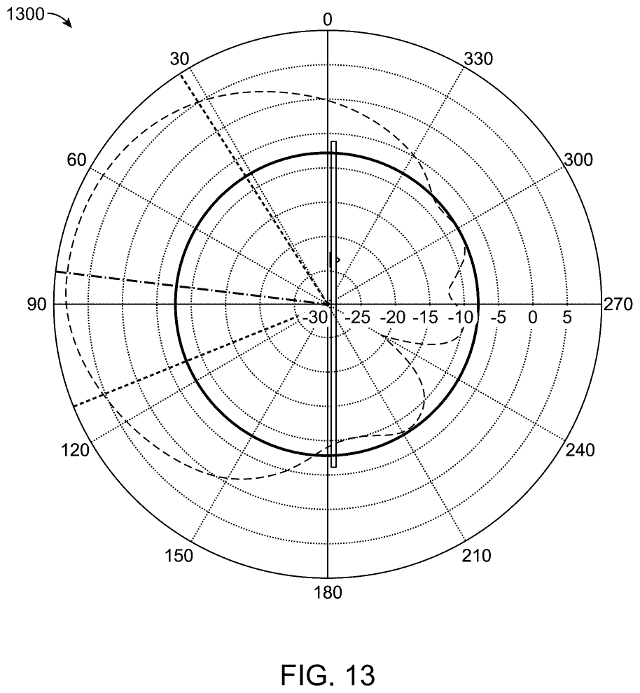

Proper electromagnetic coupling, which may be magnitude and phase, to the Parasitic Patches may be accomplished by tuning the gap (or gaps) between the Parasitic Patches and the Driven Patch, the placement of the boundary, and the geometry, which may include, but may not be limited to size and shape of the patches. The radiation patterns of the disclosed embodiment may be provided for both slant +45° and slant −45° polarized ports in FIG. 13 through FIG. 16.

In FIG. 13, graph 1300 may show an example of a +45°-polarized port azimuth plane radiation pattern of the present disclosure when it is excited by a 2.45 GHz signal. The example in graph 1300 shows the absolute realized gain of the antenna in the far-field region when the elevation angle (Theta) is 90 degrees. The horizontal axis of graph 1300 is Phi/Degree and represents the azimuth angle, which ranges from zero to 360 degrees. The vertical axis represents the gain of the antenna in decibels relative to an isotropic radiator (dBi). The frequency is 2.45 GHz with a main lobe magnitude of 8.01 dBi, a main lobe direction of 83.0 degrees, an angular width (3 dB) of 79.4 degrees, and a side lobe level of −15.8 dB.

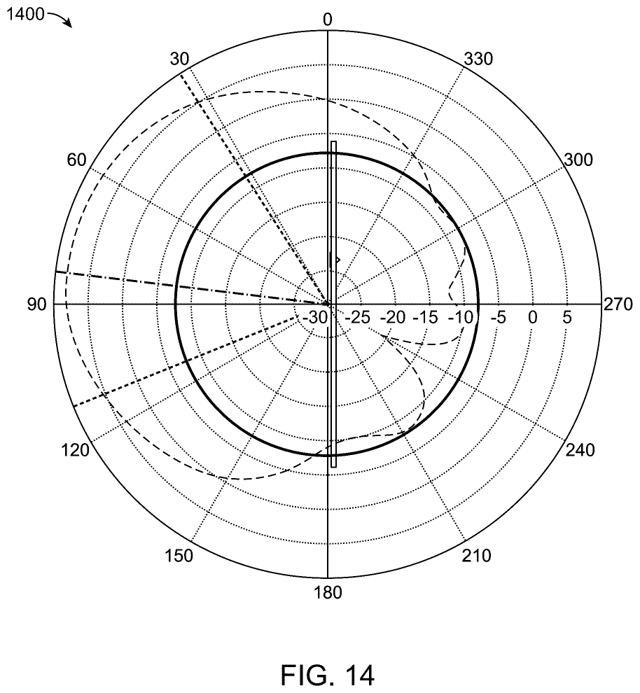

In FIG. 14, graph 1400 may show an example of a −45°-polarized port azimuth plane radiation pattern of the present disclosure when it is excited by a 2.45 GHz signal. The example in graph 1400 shows the absolute realized gain of the antenna in the far-field region when the elevation angle (Theta) is 90 degrees. The horizontal axis of graph 1400 is Phi/Degree and represents the azimuth angle, which ranges from zero to 360 degrees. The vertical axis represents the gain of the antenna in decibels relative to an isotropic radiator (dBi). The frequency may be 2.45 GHz with a main lobe magnitude of 8.03 dBi, a main lobe direction of 83.0 degrees, an angular width (3 dB) of 79.4 degrees, and a side lobe level of −15.9 dB.

In FIG. 15, graph 1500 may show an example of a +45°-polarized port elevation plane radiation pattern of the present disclosure when it is excited by a 2.45 GHz signal. The example in graph 1500 shows the absolute realized gain of the antenna in the far-field region when the azimuth angle (Phi) is 90 degrees. The horizontal axis of graph 1500 is Theta/Degree and represents the elevation angle, which ranges from zero to 180 degrees. The vertical axis represents the gain of the antenna in decibels relative to an isotropic radiator (dBi). The frequency is 2.45 GHz with a main lobe magnitude of 7.9 dBi, a main lobe direction of 92.0 degrees, an angular width (3 dB) of 52.4 degrees, and a side lobe level of −17.8 dB.

In FIG. 16, graph 1600 may show an example of a −45°-polarized port elevation plane radiation pattern of the present disclosure when it is excited by a 2.45 GHz signal. The example in graph 1600 shows the absolute realized gain of the antenna in the far-field region when the azimuth angle (Phi) is 90 degrees. The horizontal axis of graph 1600 is Theta/Degree and represents the elevation angle, which ranges from zero to 180 degrees. The vertical axis represents the gain of the antenna in decibels relative to an isotropic radiator (dBi). The frequency may be 2.45 GHz with a main lobe magnitude of 7.92 dBi, a main lobe direction of 88.0 degrees, an angular width (3 dB) of 52.4 degrees, and a side lobe level of −17.8 dB.

The design of the patch antenna as a feed network-to-antenna array transitional element provided in this disclosure is not limiting. Other arrangements may be used. One instance, for example, may include using a single patch antenna as a transitional, feed network-to-array construct, rather than a pure radiating element. In another instance, for example, simultaneously coupling to two distinct array elements, one via the electric field intensity and one via the magnetic field intensity, may be provided. Yet another instance, for example, may include efficient excitation of a compact array using a single transmission line. Another instance, for example, may include a method for achieving a compact dual-polarized array by exciting orthogonal modes on the Driven Patch.

In one instance, this design may be fabricated using common printed circuit board techniques. One common printed circuit board technique may be, for example, a 60 mil thick woven glass-reinforced ceramic substrate. Additionally, in one instance, the substrate may be made using, for example, Aerowave 300. In other instances, the substrate may be made using other techniques. However, in other instances, for example, the printed circuit board may be fabricated using other methods. In other instances, a different substrate may be used. In other instances, for example, the substrate may be thicker or thinner and may be made from a different material. In other instances, for example, the substrate may have a thickness range of 30 mils to 200 mils. Additionally, in other instances, for example, the metal of the antenna element (i.e. patch) may be fabricated from sheet metal, bent metal, or common hardware, or another material, so long as the properties are suitable for fabrication and electromagnetic performance.

In one instance, for example, the design may electrically connect the ports of the design to a radio. In one instance, a radio may be a 2.4 GHz radio. In other instances, the radio may be a different type. In one instance, the radio and patch antenna as a feed network-to-antenna array transitional element provided in this disclosure may be collocated within the same housing. In other instances, the radio and patch antenna as a feed network-to-antenna array transitional element provided in this disclosure may reside in separate housings.

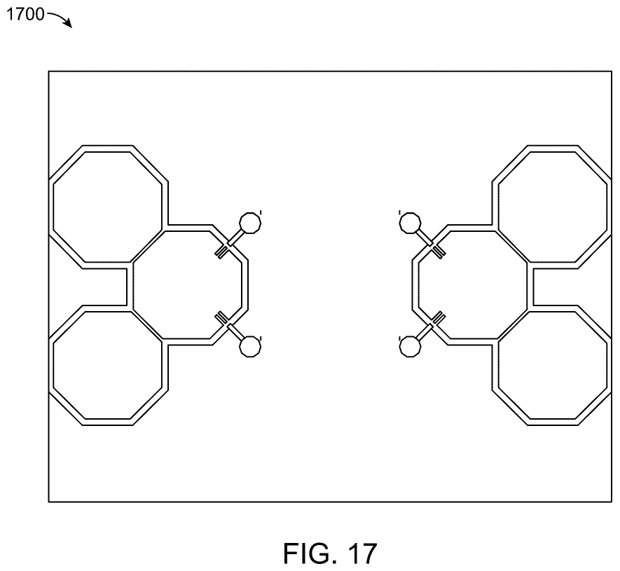

There may be a plurality of other possible configurations. In one instance, for example, as shown in FIG. 17, graph 1700, one likely configuration may deploy two of these constructs to form a 4×4 MIMO diversity platform. Graph 1700 may show an example of a 4×4 MIMO system built from two instances of the system presented in FIG. 5 that utilizes a patch antenna as a feed network-to-antenna array transitional element. In other instance, the configuration may deploy more or less than two of the constructs to form other sized platforms.

In yet other instances, other configurations are possible. In one instance, for example, those of skill in the art will recognize, according to the principles and concepts disclosed herein, that various combinations, sub-combinations, and substitutions of the components discussed above can provide appropriate control for a variety of different configurations of feed network-to-antenna array transitional elements for a variety of applications.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

Specific embodiments of the present disclosure have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present disclosure and any and all modifications, variations, or equivalents that fall within the true spirit and scope of the basic underlying principles disclosed and claimed herein.

1. A system of using a patch antenna as a feed network-to-antenna array transitional element, the system comprising:
a driven patch;
a first parasitic patch and a second parasitic patch, the driven patch couples to both the first parasitic patch and the second parasitic patch;
a first port of the driven patch that couples to the first parasitic patch via an electric field intensity and to the second parasitic patch via a magnetic field intensity; and
a second port of the driven patch that couples to the first parasitic patch via the magnetic field intensity and to the second parasitic patch via the electric field intensity,
wherein tuning a gap between the driven patch and the first parasitic patch and a gap between the driven patch and the second parasitic patch changes the magnitude and phase of the coupled fields.

2. The system of claim 1, wherein the driven patch is a half-wavelength resonant, octagonal patch.

3. The system of claim 1, wherein the first parasitic patch and the second parasitic patch each is a half-wavelength resonant, octagonal patch.

4. The system of claim 1, wherein the driven patch, the first parasitic patch, and the second parasitic patch are the same size.

5. The system of claim 1, wherein tuning results in an in-phase excitation of the 2×1 linear parasitic array.

6. The system of claim 1, further comprises a circuit.

7. The system of claim 1, wherein the circuit is realized on a 60 mil thick woven glass-reinforced ceramic substrate.

8. The system of claim 6, wherein the circuit comprises a first inductor in series with a first transmission line from the first port of the driven patch and a second inductor in series with a second transmission line from the second port of the driven patch.

9. The system of claim 7, wherein the first inductor and the second inductor are 3.9 nH.

10. A system of using a patch antenna as a feed network-to-antenna array transitional element, the system comprising:
a driven patch;
a first parasitic patch and a second parasitic patch, the driven patch couples to both the first parasitic patch and the second parasitic patch;
a first port of the driven patch that couples to the first parasitic patch via an electric field intensity and to the second parasitic patch via a magnetic field intensity;
a second port of the driven patch that couples to the first parasitic patch via the magnetic field intensity and to the second parasitic patch via the electric field intensity; and
a circuit comprising:
a first inductor and a second inductor, the first inductor is in series with a first transmission line from the first port of the driven patch and the second inductor is in series with a second transmission line from the second port of the driven patch.

11. The system of claim 10, wherein the driven patch is a half-wavelength resonant, octagonal patch.

12. The system of claim 10, wherein the first parasitic patch and the second parasitic patch each is a half-wavelength resonant, octagonal patch.

13. The system of claim 10, wherein the driven patch, the first parasitic patch, and the second parasitic patch are the same size.

14. The system of claim 10, wherein tuning a gap between the driven patch and the first parasitic patch and a gap between the driven patch and the second parasitic patch changes the magnitude and phase of the coupled fields.

15. The system of claim 14, wherein tuning results in an in-phase excitation of the 2×1 linear parasitic array.

16. The system of claim 10, wherein the first inductor and the second inductor are 3.9 nH.

17. The system of claim 10, wherein the circuit is realized on a 60 mil thick woven glass-reinforced ceramic substrate.

18. A method of using a patch antenna as a feed network-to-antenna array transitional element, the method comprising:
having a driven patch;
coupling a first parasitic patch and a second parasitic patch to the driven patch;
coupling a first port of the driven patch to the first parasitic patch via an electric field intensity and to the second parasitic patch via a magnetic field intensity; and
coupling a second port of the driven patch to the first parasitic patch via the magnetic field intensity and to the second parasitic patch via the electric field intensity,
wherein tuning a gap between the driven patch and the first parasitic patch and a gap between the driven patch and the second parasitic patch changes the magnitude and phase of the coupled fields.

19. The method of claim 18, wherein the driven patch, the first parasitic patch, and the second parasitic patch each is a half-wavelength resonant, octagonal patch.

20. The method of claim 18, wherein the driven patch, the first parasitic patch, and the second parasitic patch are the same size.

21. The method of claim 18, wherein tuning results in an in-phase excitation of the 2×1 linear parasitic array.

22. The method of claim 18, further comprises having a circuit,
wherein the circuit is realized on a 60 mil thick woven glass-reinforced ceramic substrate, and
wherein the circuit comprises a first inductor in series with a first transmission line from the first port of the driven patch and a second inductor in series with a second transmission line from the second port of the driven patch, wherein the first inductor and the second inductor are 3.9 nH.
